(19) United States
(12) Patent Application Publication
(10) Pub. No.: US 2013/0156527 A1
(43) Pub. Date: Jun. 20, 2013

(54) SELF-ALIGNING TRI-LOBED LUG AND ASSEMBLY

(71) Applicant: Ronald M. Hutchinson, Brookfield, WI (US)

(72) Inventor: Ronald M. Hutchinson, Brookfield, WI (US)

(21) Appl. No.: 13/555,449

(22) Filed: Jul. 23, 2012

Related U.S. Application Data
(60) Provisional application No. 61/521,108, filed on Aug. 8, 2011.

(51) Int. Cl. F16B 33/00; F16B 43/00

(52) U.S. Cl. CPC F16B 33/00; F16B 43/00
USPC 411/368; 411/511; 411/366.1

(57) ABSTRACT

A tri-lobed lug has a centrally disposed aperture which allows the lug to rotate 360° about its axis. Each lobe of the lug can be used to secure an attachment means to it. This could be a rope, strap or other similar structure. Each lobe can also be used to loop such rope, strap, bungee cord hook or other structure through an aperture defined in the lobe. When such structure is secured to the lug, the lug can align itself in a direction of maximum strength. The lug portions further comprise rounded surfaces to prevent cutting or serration of the rope, strap or other similar structure. The tri-lobed lug is also used in an assembly comprising a bolt-like element, a bushing and a nut to attach the lug to a surface. The assembly may further comprise washer-like elements to prevent damage to the surface.

This application claims the benefit and priority of U.S. Provisional Patent Application No. 61/521,108 filed Aug. 8, 2011.

### FIELD OF THE INVENTION

The present invention relates generally to devices and fasteners used to secure or anchor one or more items to another item. It also relates generally to motorcycles, motor vehicles and accessories for motorcycles and motor vehicles. More specifically, the present invention relates to a self-aligning lug and assembly that can be mounted into certain surfaces of a motorcycle or vehicle for the purpose of attaching items to the motorcycle or vehicle using a rope, strap, bungee cord or other tying means. It also relates to such a lug that has three lobes to it, each lobe being capable of having a tie structure looped through it or secured to it.

### BACKGROUND OF THE INVENTION

Various surface-mountable devices are known in the relevant art. Such devices include tie-down rings, loops and fingers, among other similar structures. Some of those devices allow for movement of a ring, for example, where the ring is secured to a surface mount and allowed to pivot or rotate substantially 180° relative to the surface to which the device is mounted. The problem with such devices, however, is that the tie-down structure is typically secured to a surface in a fixed relationship or position. In the case of the rotatable ring, its inability to pivot or rotate does not allow the ring to maximize its load-bearing capacity. Such side loading could potentially result in the ring failing or the entire device failing due to the stresses that side loading exerts on the tie-down structure due to this fixed placement.

In the view of this inventor, there is a need to provide a tie- down structure in the form of a self-aligning lug which allows the structure to align the lug in a direction that maximizes the lug's load-bearing capacity. There is also a need to provide such a structure whereby the lug is fully rotatable 360° about an axis. There is also a need to provide such a self-aligning lug that is tri-lobed such that up to three securing straps, lines, bungee cord hooks or the like may be secured to the lug or looped through it, all at one time. There is also a need to provide such a structure that is simple in design and easy to use.

Accordingly, it is an object of the present invention to provide a tie-down structure in the form of a self-aligning lug which allows the structure to align the lug in a direction of maximum strength and which allows the lug to rotate 360° about an axis. It is another object of the present invention to provide such a self-aligning lug that is tri-lobed such that up to three securing straps, lines, hooks or the like may be secured to one or more of the lobes of the lug or looped through the lobes of the lug, and all at one time. It is still another object of the present invention to provide such a structure that is simple in design and easy to use.

### SUMMARY OF THE INVENTION

The device of the present invention has obtained these objects. It provides for tri-lobed lug having a centrally disposed aperture which allows the lug to rotate 360° about its axis. Each lobe of the lug can be used to secure an attachment means to it. This could be a rope, strap or other similar structure. Each lobe can also be used to loop such rope, strap, bungee cord hook or other structure through an aperture defined in the lobe. When such structure is secured to the lug, the lug can align itself in a direction of maximum strength.

The foregoing and other features of the self-aligning lug of the present invention will be apparent from the detailed description that follows.

### BRIEF DESCRIPTION OF THE DRAWINGS

FIG. 1 is a side perspective view of a self-aligning lug that is constructed in accordance with the present invention.

FIG. 2 is a top plan view of the self-aligning lug shown in FIG. 1.

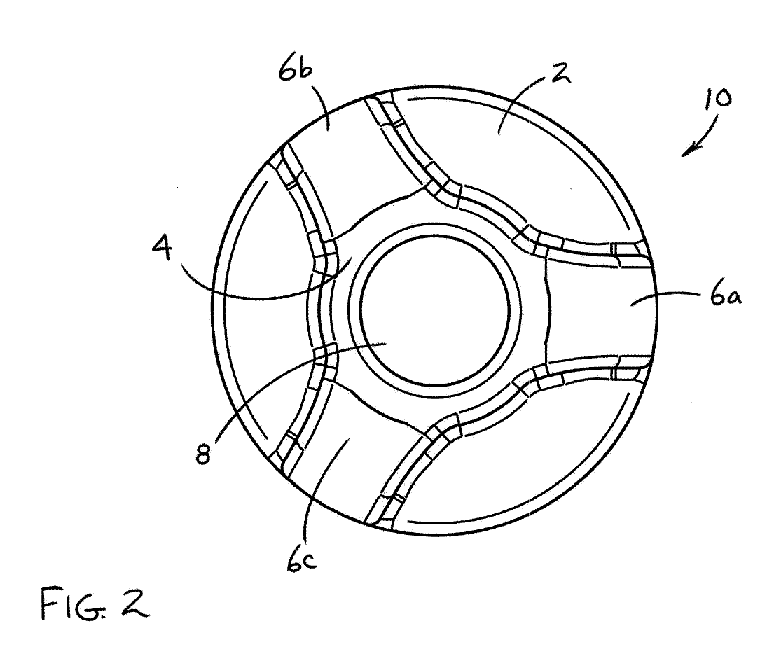

FIGS. 3A and 3B are side elevational views, shown at two different points of rotation, of the self-aligning lug shown in FIGS. 1 and 2.

FIG. 4 is an exploded perspective view of an assembly that would use the self-aligning lug in accordance with the present invention.

### DETAILED DESCRIPTION

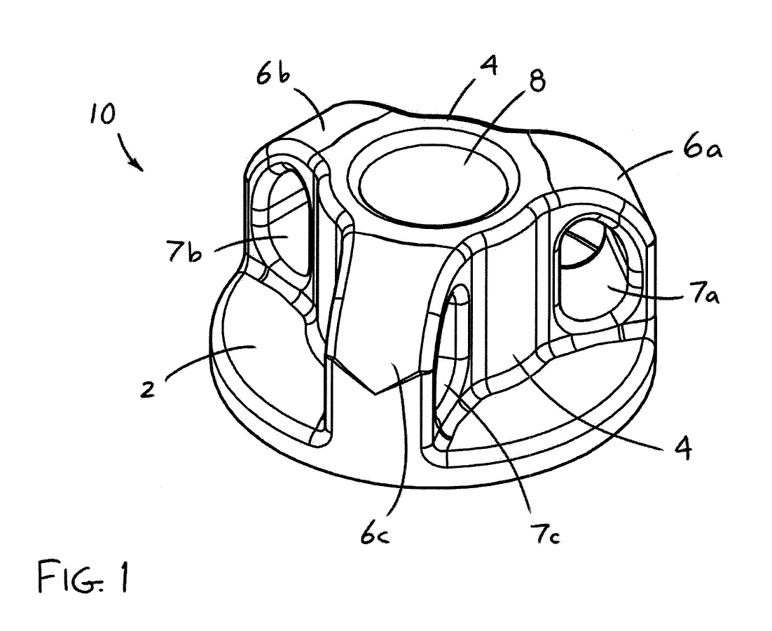

Referring now to the drawings in detail, FIG. 1 illustrates a representative structure, generally identified 10, which is a preferred embodiment of a self-aligning lug that is fabricated in accordance with the present invention.

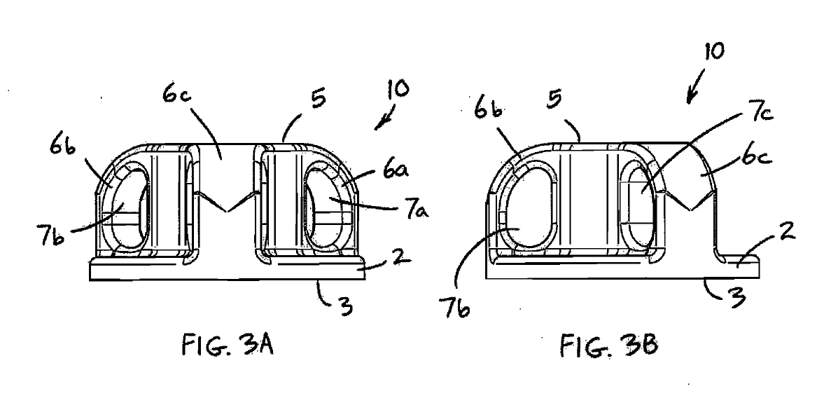

As shown, the self-aligning lug 10 comprises a substantially round and disk-like base portion 2. The base portion 2 has a substantially flat bottom surface 3. See FIGS. 3A and 3B. Extending upwardly from the base portion 2 is a vertical core or central portion 4 having a vertically-disposed and cylindrically-shaped aperture 8 defined in it. The central portion 4 of the lug 10 further comprises a top surface 5. Also extending upwardly from the base portion 2 of the lug 10 are three closed curved or rounded parts, or lobes 6a, 6b, 6c. Each lobe 6a, 6b, 6c is, on center, disposed 120° away from the next adjacent lobe. Defined within each lobe 6a, 6b 6c is a corresponding lobe aperture 7a, 7b, 7c. Structurally, each lobe and aperture could also be referred to herein as a “loop.” Each lobe aperture 7a, 7b, 7c is functionally adapted to receive a fastener or other fastening structure through it, such as the metal or plastic hook of a bungee cord. It should be noted that the preferred embodiment of the lug 10 of the present invention comprises rounded surfaces to prevent cutting or serration of the strap, rope or other structure (not shown) that may be attached to or looped through the lobe aperture 7a, 7b, 7c.

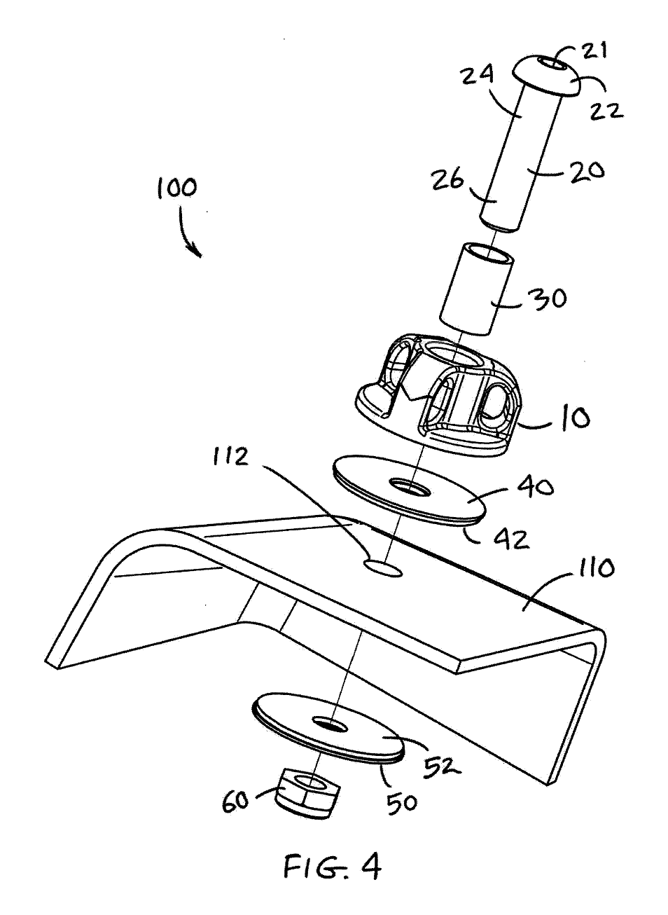

Referring now to FIG. 4, it shows, in exploded view, an assembly, generally identified 100, that uses the lug 10 in combination with other securement elements. Those elements include a bolt-like element 20, the bolt-like element 20 having a head 22 with a drive aperture 21 defined within the head 22. Extending downwardly from the head 22 is an upper shaft portion 24. Extending further downwardly from the upper shaft portion 24 is a threaded lower shaft portion 26. The shaft portions 24, 26 are receivable within the central aperture 8 of the lug 10. FIG. 4 also illustrates a bushing 30 that is disposed between the lug aperture 8 and the upper shaft portion 24. In this fashion, and when fully assembled, the lug 10 can freely rotate 360° about the upper shaft portion 24 of the bolt-like element 20, the length of the bushing 30 being just slightly longer than the distance between the bottom surface 3 of the lug 10 and the top surface 5 of the lug 10. In an alternative embodiment, the upper shaft portion 24 of the bolt-like element 20 could be configured to have an outer diameter that is slightly smaller than the inner diameter of the central aperture 8 of the lug 10, and the shank 24 forming a shoulder (not shown) with the upper shaft portion 26 having a length just slightly longer than the height of the lug 10 such that the shoulder prevents the lug 10 from being held in a fixed position and unable to rotate. In this alternative embodiment, use of the bushing 30 would not be necessary.

Below the lug 10 is a first washer-like element 40 on which the bottom surface 3 of the lug 10 rests, after assembly. In this assembly 100, the coefficient of friction between the bottom surface 3 of the lug 10 and the face of the first washer-like element 40 should be low. Similarly, the coefficient of friction between the top surface 5 of the lug 10 should be low in relation to the underside of the head 22 of the bolt-like element 20. Below the first washer-like element 40 is a cushioning layer 42 which is preferably made of a rubber material to prevent scuffing or damage to the surface 110 to which the assembly 100 is attached via the aperture 112, the aperture 112 being sized to receive the lower shaft portion 26 of the bolt-like element 20. The cushioning layer 42 also seals the aperture 112 of the surface 110. Underneath the surface 110, and below that side of the surface 110 that supports the lug 10, a second washer-like element 50 is provided. This second washer-like element 50 similarly includes a cushioning layer 52, also to prevent damage to the surface 110. Lastly, the assembly 100 can be secured by means of securing a like-threaded nut 60 to the threaded lower shaft portion 26 of the bolt-like member 20. In this fashion, the lobes 6a, 6b, 6c of the lug 10 may be used to attach a strap or other securing member (not shown) to the lug 10. When attached, the lug 10 will freely rotate about the upper shaft portion 24 of the bolt-like member 20 and the interposed bushing 30 and orientate itself in a position that exerts the least amount of stress on the lug 10 and the respective lobe 6a, 6b, 6c.

It should also be mentioned that, in the preferred embodiment of the present invention, the lug 10 portions are integrally formed as a single structure. The lug 10 and its component structures may be made of a metal material, a plastic material or other material that is strong enough to allow the stress of a fastener to be imposed on the lug 10 without a failure of the lug 10 at any one or more of the lobes 6a, 6b, 6c. Further, it is to be noted that the lobes 6a, 6b, 6c and the lobe apertures 7a, 7b, 7c of the lug 10 are formed to be substantially rounded so as to avoid any edges that could otherwise cut into or sever the strap, rope or other structure that could be attached to or looped through the lug portions.

In view of the foregoing, it will be appreciated that the present invention provides a tri-lobed lug having a centrally disposed vertical aperture which allows the lug to rotate 360° about its axis. Each lobe of the lug can be used to secure an attachment means to it. This could be a rope, strap, bungee cord hook or other similar structure. Each lobe can also be used to loop such rope, strap or other structure through an aperture defined in the lobe. When such structure is secured to the lug, the lug can align itself in a direction of maximum strength.

The details of the invention having been disclosed in accordance with the foregoing, I claim:

1. A self-aligning lug comprising:
a disk-like base portion;
a central portion extending upwardly from the base portion;
a cylindrically-shaped aperture defined within the central portion;
three lobes extending between the base portion and the central portion; and
an aperture disposed within each lobe, each aperture being functionally adapted to receive a fastener or other fastening structure through it.

2. The self-aligning lug of claim 1 wherein each lobe is disposed 120° away from the next adjacent lobe.

3. The self-aligning lug of claim 1 wherein a portion of a bolt-like element disposed within the central portion aperture will allow the lug to freely rotate 360° about the portion of the bolt-like element.

4. The self-aligning lug of claim 3 wherein the lug is configured to orientate itself in a position that exerts the least amount of stress on the lug and the respective lobes when a fastening structure is received by one or more of the lobe apertures.

5. The self-aligning lug of claim 1 wherein the lug components are comprised of an integrally-formed single structure.

6. The self-aligning lug of claim 5 wherein the lug is fabricated of a metal or plastic material.

7. The self-aligning lug of claim 1 wherein the lug components comprise rounded surfaces to prevent cutting or serration of a strap, rope or other structure that may be attached to or looped through one or more of the lobe apertures.

8. A self-aligning lug assembly that is attachable to a surface, the surface having an aperture, the assembly comprising:
a lug comprising a disk-like base portion; a central portion extending upwardly from the base portion; a cylindrically-shaped aperture defined within the central portion; three lobes extending between the base portion and the central portion; and an aperture disposed within each lobe, each aperture being functionally adapted to receive a fastener or other fastening structure through it;
a bushing, the bushing being receivable within the cylindrically-shaped aperture of the lug;
a bolt-like element, the bolt-like element being receivable within the bushing and having shaft, the shaft comprising a threaded portion; and
a nut, the nut comprising a threaded portion for securing the assembly to the surface.

9. The self-aligning lug assembly of claim 8 wherein a pair of washer-like elements are interposed within the assembly and positioned immediately adjacent the surface to provide a seal to the hole in the panel and prevent damage to the surface.

10. The self-aligning lug assembly of claim 9 wherein the washer-like elements are comprised of a cushioning layer.

11. The self-aligning lug assembly of claim 8 wherein lug base comprises a bottom surface and wherein the coefficient of friction between the bottom surface of the lug base and the washer-like element is low.

12. The self-aligning lug assembly of claim 8 wherein the bushing and a portion of the bolt-like element disposed within the central portion aperture will allow the lug to freely rotate 360° about the portion of the bolt- like element.

13. The self-aligning lug assembly of claim 12 wherein the lug is configured to orientate itself in a position that exerts the least amount of stress on the lug and the respective lobes when a fastening structure is received by one or more of the lobe apertures.

14. The self-aligning lug assembly of claim 8 wherein the lug components are comprised of an integrally-formed single structure.

15. The self-aligning lug assembly of claim 14 wherein the lug is fabricated of a metal or plastic material.

16. The self-aligning lug assembly of claim 8 wherein the lug components comprise rounded surfaces to prevent cutting or serration of a strap, rope or other structure that may be attached to or looped through one or more of the lobe apertures.

17. The self-aligning lug assembly of claim 8 wherein each lobe is disposed 120° away from the next adjacent lobe.
